(19) United States
(12) Patent Application Publication
(10) Pub. No.: US 2026/0172996 A1
(43) Pub. Date: Jun. 18, 2026

(54) METHODS FOR ENABLING MULTI-LINK MILLIMETER WAVE ADVERTISEMENT

(71) Applicant: INTERDIGITAL PATENT HOLDINGS INC., Wilmington, DE (US)

(72) Inventors: Hanqing LOU, Syosset, NY (US); Zinan LIN, Basking Ridge, NY (US); Xiaofei WANG, North Caldwell, NJ (US); Mahmoud SAAD, Montreal, CA (US); Rui YANG, Greenlawn, NY (US)

(73) Assignee: INTERDIGITAL PATENT HOLDINGS INC., Wilmington, DE (US)

(21) Appl. No.: 19/123,475

(22) PCT Filed: Nov. 9, 2023
(86) PCT No.: PCT/US2023/037072

§ 371 Date: Apr. 23, 2025

Related U.S. Application Data
(60) Provisional application No. 63/423,986, filed on Nov. 9, 2022.
(60) Provisional application No. 63/512,420, filed on Jul. 7, 2023.
(60) Provisional application No. 63/514,712, filed on Jul. 20, 2023.

(51) Int. Cl. H04W 56/00; H04B 7/06; H04L 1/00

(52) U.S. Cl. CPC H04W 56/0015; H04B 7/06966; H04L 1/0003

(57) ABSTRACT

A station (STA) multilink device (MLD) may comprises a first STA affiliated with the STA MLD and a second STA affiliated with the STA MLD. The first STA may be configured to receive, from a first access point (AP) affiliated with an AP MLD, a first management frame over a first link. The first management frame may comprise timestamp information. The first STA may be configured to receive, from the first AP, a second management frame over the first link. The second management frame may comprise a time synchronization function (TSF) offset. The second STA may be configured to receive, from a second AP affiliated with the AP MLD, based on the timestamp information and the TSF offset, at least one third management frame from a set of third management frames over a second link. The at least one third management frame may be transmitted using a sector sweep.

### CROSS-REFERENCE TO RELATED APPLICATION

This application claims the benefit of U.S. Provisional Application No. 63/423,986, filed Nov. 9, 2022; U.S. Provisional Application No. 63/512,420, filed Jul. 7, 2023 and U.S. Provisional Application No. 63/514,712, filed Jul. 20, 2023, the contents of which are incorporated herein by reference.

### BACKGROUND

A wireless local area network (WLAN) in Infrastructure Basic Service Set (BSS) mode has an Access Point (AP) for the BSS and one or more stations (STAs) associated with the AP. The AP typically has access or interface to a Distribution System (DS) or another type of wired/wireless network that carries traffic in and out of the BSS. Traffic to STAs that originates from outside the BSS arrives through the AP and is delivered to the STAs. Traffic originating from STAs to destinations outside the BSS is sent to the AP to be delivered to the respective destinations. Traffic between STAs within the BSS may also be sent through the AP where the source STA sends traffic to the AP and the AP delivers the traffic to the destination STA.

### SUMMARY

A station (STA) multilink device (MLD) may comprises a first STA affiliated with the STA MLD and a second STA affiliated with the STA MLD. The first STA affiliated with the STA MLD may be configured to receive, from a first access point (AP) affiliated with an AP MLD, a first management frame over a first link. The first management frame may comprise timestamp information. The first STA affiliated with the STA MLD may be configured to receive, from the first AP, a second management frame over the first link. The second management frame may comprise a time synchronization function (TSF) offset. The second STA affiliated with the STA MLD may be configured to receive, from a second AP affiliated with the AP MLD, based on the timestamp information and the TSF offset, at least one third management frame from a set of third management frames over a second link. The at least one third management frame from the set of third management frames may be transmitted using a sector sweep. Each third management frame may be transmitted using one antenna sector. The first link may be a sub-7 GHz link. The second link may be a millimeter wave (mmW) link. The first STA affiliated with the STA MLD may be configured to send, to the first AP over the first link, feedback information regarding the second link and the received at least one third management frame. The feedback information regarding the received at least one third management frame may comprise a sector identification, a third management frameset identification, or countdown information. The second STA affiliated with the STA MLD may be configured to determine a transmission time of the at least one third management frame based on a target third management frame transmission time field in the second management frame. The first management frame may comprise a basic multi-link element. The basic multi-link may indicate that the second link is active. The first management frame may be a beacon frame. The second management frame may be a multi-link beacon assistant frame. The third management frame may be a short beacon frame (SBF). The second management frame may comprise: a target multi-link beacon assistant transmission time field that indicates a transmission time of a next second management frame transmitted over the first link; a multi-link beacon assistant interval field that indicates a number of time units (TU)s between second management frames; a target short beacon transmission time field that indicates a transmission time of a next set of third management frames transmitted over the second link; a short beacon set size field that indicates a number of third management frames in a set of third management frames; a short beacon interval field that indicates a number of times between an end of a last third management frame in a current set of third management frames to a first third management frame in a next set of third management frames; a timestamp field; a TSF offset subfield that indicates an offset between a TSF timer of AP1 and a TSF timer of AP2; a multi-link operation element that comprises information for multi-link operation; and a multi-link capabilities element. The multi-link capabilities element may comprise: a hieratical beam training field; a receive beam training field; a mmW beam or antenna reciprocity field; a number of receive mmW antennas field; a number of sectors or beams field; a supported mmW bandwidth field; a supported mmW modulation and coding scheme (MCS) field; and a supported number of data streams field. The at least one third management frame may comprise: a sector sweep field that indicates a position of the third management frame in the set of third management frames; a timestamp field; and a short beacon interval field that indicates a number of times between an end of a last third management frame in a current set of third management frames to a first third management frame in a next set of third management frames.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 shows an exemplary mmW Timestamp Field Format;

FIG. 3 shows an exemplary enhanced Multi-Link element to include information of mmW links;

FIG. 4 shows an exemplary Common Info field of enhanced Basic Multi-Link element;

FIG. 5 shows an exemplary Enhanced MLD Capabilities and Operations subfield;

FIG. 6 shows an exemplary Optional subelement IDs for Link Info field of the Multi-Link element;

FIG. 7 shows an exemplary mmW Per-STA Profile subelement format;

FIG. 8 shows an exemplary mmW STA Control subfield format;

FIG. 9 shows an exemplary mmW STA Info subfield format;

FIG. 10 shows an exemplary modified STA Control field;

FIG. 11 shows an exemplary modified STA Info field;

FIG. 12 shows an example combined procedure of Short Beacon frame and mmW Beacon Assistant frame;

FIG. 13 shows an example method of using a Short Beacon frame and a mmW Beacon Assistant frame; and

FIG. 14 shows an example method of using a Short Beacon frame and a mmW Beacon Assistant frame.

### DETAILED DESCRIPTION

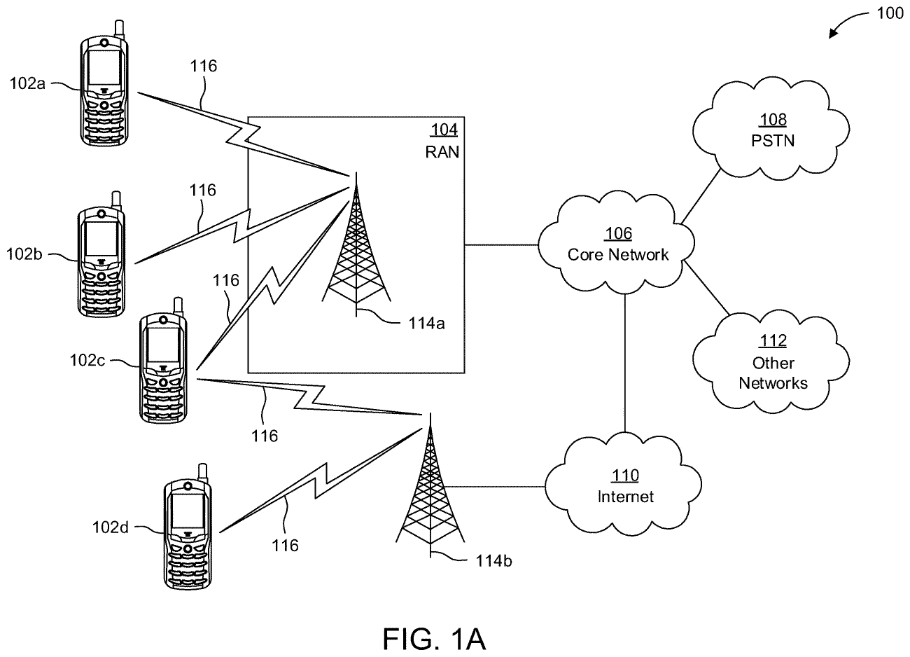

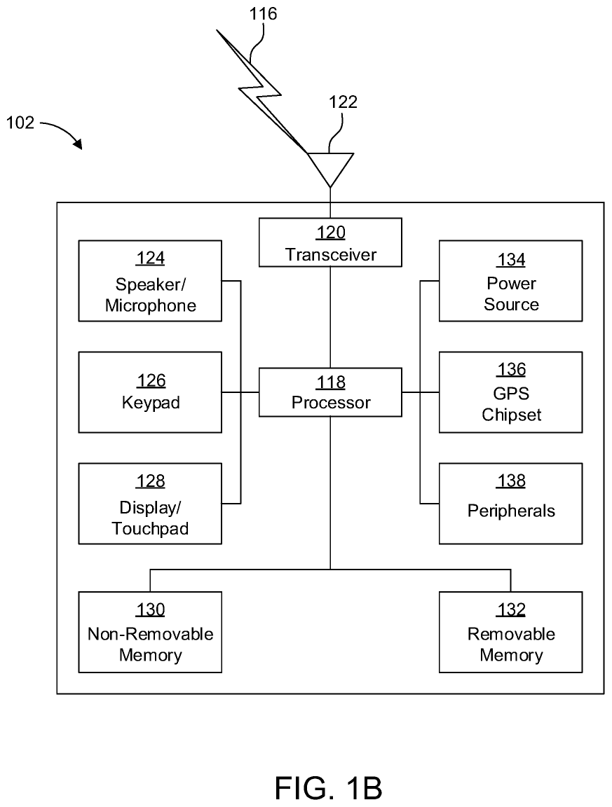

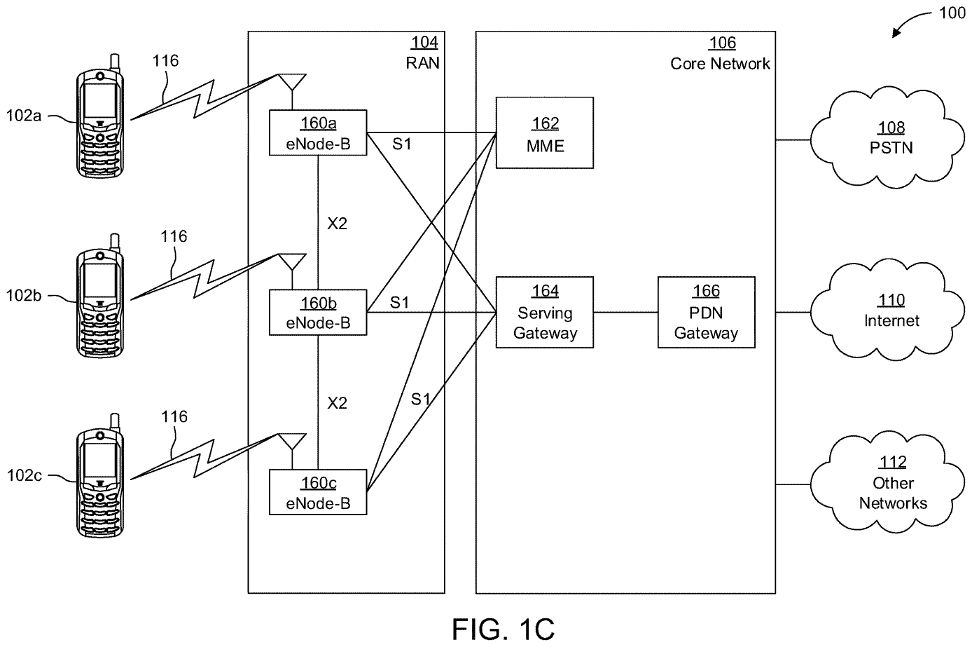

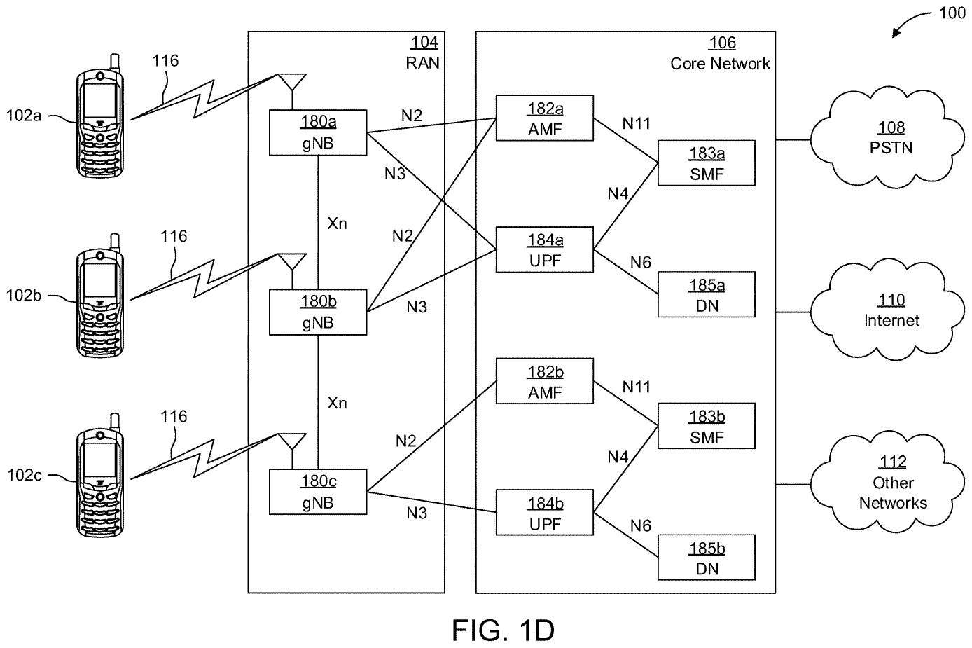

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHZ, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a, 184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Using an 802.11 ac infrastructure mode of operation, an AP may transmit a beacon on a fixed channel, usually a primary channel. This channel may be 20 MHz wide, and may be the operating channel of the BSS. This channel may also be used by the STAs to establish a connection with the AP. The fundamental channel access mechanism in an 802.11 system is Carrier Sense Multiple Access with Collision Avoidance (CSMA/CA). In this mode of operation, every STA, including the AP, will sense the primary channel. If the channel is detected to be busy, the STA backs off. Hence only one STA may transmit at any given time in a given BSS.

In 802.11n, High Throughput (HT) STAs may also use a 40 MHz wide channel for communication. This is achieved by combining the primary 20 MHz channel with an adjacent 20 MHz channel to form a 40 MHz wide contiguous channel.

In 802.11ac, Very High Throughput (VHT) STAs may support 20 MHz, 40 MHz, 80 MHz, and 160 MHz wide channels. The 40 MHz and 80 MHz channels are formed by combining contiguous 20 MHz channels similar to 802.11n described above. A 160 MHz channel may be formed either by combining eight contiguous 20 MHz channels, or by combining two non-contiguous 80 MHz channels, which may also be referred to as an 80+80 configuration. For the 80+80 configuration, the data, after channel encoding, is passed through a segment parser that divides it into two streams. IFFT and time domain processing are done on each stream separately. The streams are then mapped onto the two channels and the data is transmitted. At the receiver, this procedure is reversed and the combined data is sent to the MAC.

To improve spectral efficiency, 802.11ac has introduced the concept for downlink Multi-User MIMO (MU-MIMO) transmission to multiple STAs in the same symbol's time frame (e.g. during a downlink OFDM symbol). The potential for the use of downlink MU-MIMO is also currently considered for 802.11ah. Since downlink MU-MIMO, as it is used in 802.11ac, uses the same symbol timing to multiple STAs, interference of the waveform transmissions to multiple STAs is not an issue. However, all STAs involved in MU-MIMO transmission with the AP must use the same channel or band, which limits the operating bandwidth to the smallest channel bandwidth that is supported by the STAs which are included in the MU-MIMO transmission with the AP.

Multi-Link operation (MLO), introduced in 802.11be, enables a non-AP multi-link device (MLD) to discover, authenticate, associate, and set up multiple links with an AP MLD. An AP (referred to as a reporting AP) affiliated with an AP MLD may advertise operating capabilities and operating parameters of another AP (referred to as a reported AP) affiliated with the same AP MLD by including a Multi-Link Element. Each link enables channel access and frame exchanges between the non-AP MLD and the AP MLD based on the supported capabilities exchanged during association.

An IEEE 802.11 UHR Study Group was formed in July 2022 to create a project authorization request (PAR) to create an 802.11 Task Group to standardize improved reliability of WLAN connectivity, reduce latencies, increase manageability, and increase throughput consumption.

Millimeter wave (mmW or mmWave) operation is considered as a potential feature to achieve these goals, especially considering the development of multi-link operation (MLO) in 802.11be.

mmWave operation may be the most relevant feature that matches the UHR objectives. All devices operating in a mmWave band/link should be MLO-capable and should have at least one active sub-7 GHz link. The discovery and association procedure should be done in a lower band/link. Scheduling and broadcast should be from a lower band/link. Beamforming (BF) training with sector sweep (SS) should be done in mmW band/link, but BF training sequence may be triggered or scheduled from a lower band and feedback may be provided in a lower band.

Transmissions in mmW links are usually highly directional since the mmW link channel has a large pathloss. Therefore, with the help of MLO, operations in mmW links may not be standalone and some management frames and control frames for mmW links may be transmitted in sub-7 GHz links. Time synchronization procedures defined in 802.11 usually rely on a Beacon frame which carries a Timestamp field for non-AP STAs to adjust their timing synchronization function (TSF) timers. In a non-standalone mmW link, it needs to be determined how a non-AP STA synchronizes with an AP given the assumption that a Beacon frame or some part of the Beacon frame may be transmitted in a sub-7 GHz link.

Transmission on a mmW link may utilize different numerology from that in a sub-7 GHz link. For example, the subcarrier spacing in a mmW link may be larger than that in a sub-7 GHz link, and thus the OFDM symbol duration in a mmW link may be shorter than that in a sub-7 GHz link. As a result, the original TSF timer that works well in a sub-7 GHz link may not work well in a mmW link.

Operation information about a mmW link needs to be advertised by the AP to non-AP STAs, so that they may associate to each other and then communicate to each other. Normally the transmission in a mmW link may be highly directional and thus broadcast information may be transmitted in sub-7 GHz links. It needs to be determined how to advertise the mmW link operation information in a sub-7 GHz link.

Moreover, non-AP STAs may need to exchange or send its capabilities to the AP during association and link setup procedures when the beam training usually has not been done and highly directional transmission is not possible. With the help of MLO, the transmission of mmW capabilities may be moved to sub-7 GHz links and a detailed procedure may be needed.

A mmW link in MLO may not be a standalone link (i.e. may be a non-standalone link). Some management frames and/or broadcast frames for mmW operation may be transmitted over one or more sub-7 GHz links. In an embodiment, a Beacon frame may not be transmitted over the mmW link(s). To synchronize with an AP, a non-AP STA in a mmW link affiliated with a non-AP STA MLD may adjust its TSF timer based on a timestamp in a sub-7 GHz link or a lower frequency link.

To support mmW operations in an MLO system, an anchor link and a dependent link may be defined.

An anchor link may be a link on which a STA MLD may perform time synchronization for a STA affiliated with the same MLD but operating on a dependent link. Usually, an anchor link is a sub-7 GHz link. An AP operating on an anchor link may be referred as the Anchor AP.

A dependent link may be a link on which a STA may not obtain time synchronization information and/or other BSS level information from another link. Usually, a dependent link is a mmW link. An AP operating on a dependent link may be referred as the dependent AP (or in some places a mmW AP).

A STA affiliated with a STA MLD operating on a mmW link may consider the mmW link as a dependent link. For each dependent link, a STA MLD may indicate a sub-7 GHz link as an anchor link for the dependent link.

In an embodiment, if the STA MLD may be active on more than one dependent link, the STA MLD may select a sub-7 GHz link as an anchor link for all the dependent links. In this embodiment, an MLD may have one anchor link. In an embodiment, if the STA MLD may be active on more than one dependent link, for each dependent link, the STA MLD may select a sub-7 GHz link as its anchor link. In this embodiment, more than one anchor link may be possible for an MLD.

In an embodiment, an AP MLD with at least one affiliated mmW AP may announce an anchor link for the associated non-AP MLDs and thus non-AP MLDs which may want to operate on the mmW link(s) may need to be active on the anchor link (i.e. associated with the AP operating in the anchor link) In an embodiment, scheduling information, such as TWT element, TIM element, Trigger frame, etc., for the dependent link(s) may be transmitted in the corresponding anchor link(s). In an embodiment, the scheduling information for the dependent link(s) may be transmitted in any sub-7 GHz link.

In an embodiment, a Beacon frame transmitted in an anchor link may comprise a Timestamp field which may be used for time synchronization for the anchor link and its dependent link(s).

A STA affiliated with a STA MLD operating on a dependent link may also need to be active on an anchor link. The STA MLD may maintain a separate TSF timer for the anchor link and the dependent link(s). It may check the Beacon frame transmitted on the anchor link periodically. It may update its TSF timer of the anchor link based on the Timestamp field of the received Beacon frame on the anchor link. It may update its TSF timer of the mmW link(s) based on the Timestamp field of the received Beacon frame on the anchor link. In an embodiment, the TSF timer on the anchor link and the dependent link(s) may be the same and thus the STA MLD may maintain one TSF timer for the anchor link and dependent links. In an embodiment, the TSF timer on the anchor link and the dependent link(s) may be different. In this embodiment, a Timestamp Difference field/element may be carried in the Beacon frame transmitted on the anchor link to indicate the Timestamp Difference or offset between the anchor link and the dependent link(s), so that the receiving STA MLD may adjust its TSF timer for the dependent link(s) accordingly.

Alternatively or additionally, the STA MLD may maintain one TSF timer for the anchor link and dependent link(s). The TSF timer may be referred to as a common TSF timer. The STA MLD may update the common TSF timer based on the Timestamp field of the received Beacon frame on the anchor link. The STA MLD may use the common TSF timer for any scheduling on the anchor link and/or the dependent link(s).

In an embodiment, a Timestamp field carried in an anchor link may not provide enough accuracy or resolution to synchronize the transmissions and receptions over mmW links. To synchronize mmW transmissions, an Additional/Extended Timestamp for mmW field may be used and together with a Timestamp field, a mmW device may update its TSF timer more precisely.

In an embodiment, the Timestamp field may be specific to each link. The Timestamp fields for mmW links may be carried explicitly in every sub-7 GHz link.

In an embodiment, each sub-7 GHz AP affiliated with an AP MLD which has at least one affiliated AP operating on a mmW link may have multiple Timestamp fields carried in its Beacon frame, Probe Response frame or (Re)Association Response frame. The first Timestamp field may be the Timestamp for the link on which the Beacon frame is transmitted (i.e. a sub-7 GHz link). The rest of the Timestamp fields may be for the mmW links on which the APs affiliated with the same AP MLD may operate.

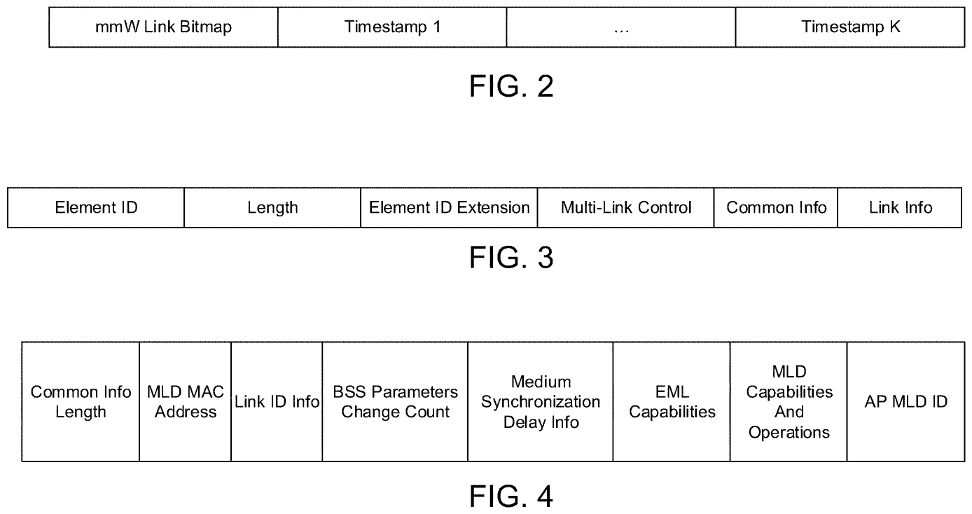

In an embodiment, the Timestamp fields for mmW links together may be included in a mmW Timestamp field/element, and the mmW Timestamp field/element may be carried in the Beacon frame transmitted in a sub-7 GHz link. An exemplary mmW Timestamp field is shown in FIG. 2. The mmW Link Bitmap subfield may be a bitmap to indicate the active mmW links in the AP MLD. This subfield may be present when the number of active mmW links is greater than 1. The Timestamp subfields may indicate the Timestamp for the kth mmW AP affiliated with the AP MLD. k=1, . . . , K and K may be determined by the mmW Link Bitmap field and may indicate the number of active mmW links for the AP MLD.

In an embodiment, if the AP MLD may be active on more than one mmW link (e.g. K mmW links), the different mmW links may have different TSF timers. The number of Timestamp fields carried in the Beacon frame in each sub-7 GHz link may be K+1, or the number of Timestamp fields in the mmW Timestamp field/element may be K.

In an embodiment, if the AP MLD may be active on more than one mmW link (e.g. K mmW links), the different mmW links may have the same TSF timer. The number of Timestamp fields carried in the Beacon frame in each sub-7 GHz link may be two or the number of Timestamp field in the mmW Timestamp field/element may be one.

The mmW Timestamp field/element (or Timestamp fields for mmW links) may be carried in a (Re)Association Response frame and/or a Probe Response frame and/or other type of management/control frames so that a non-AP STA MLD may acquire the TSF timer in an association procedure.

The mmW Timestamp field/element (or Timestamp fields for mmW links) may be carried in a Reduced Neighbor Report (RNR) element, Neighbor Report element, or other element/field.

A Short Beacon frame may be defined and transmitted in a mmW link periodically with sector sweeping transmission. The Short Beacon frame transmitted in a mmW link may be used for one or more purposes described herein.

The Short Beacon frame transmitted in a mmW link may be used for time synchronization between an AP and non-AP STAs in a mmW link. The Short Beacon frame may comprise a Timestamp field or other time related field/elements so the non-AP STAs may update their TSF timer.

The Short Beacon frame transmitted in a mmW link may be used for sector sweep beam training between an AP and non-AP STAs in a mmW link. The Short Beacon frame may be transmitted with sector sweeping. The Short Beacon frame transmission duration, and/or target beacon transmission time (TBTT) of the Short Beacon frame, and/or number of sectors sweeps for the Short Beacon frame transmission, and/or the ending time of the Short Beacon frame sectorized transmission may be signaled by the AP MLD over one or more sub-7 GHz link so that the mmW non-AP STAs may obtain the transmission schedule of the Short Beacon frames and perform AP transmit beam training during the Short Beacon transmit time.

The Short Beacon frame transmitted in a mmW link may be used for link/beam maintain and recovery. The Short Beacon frames may be transmitted periodically at the beginning of each beacon interval in a mmW link. A mmW non-AP STA may monitor the Short Beacon frames to maintain the link between the AP and the non-AP STA, and re-train the AP transmit beams if the existing beam is not good enough. If the non-AP STA may not receive the Short Beacon frames or the reception quality (e.g. through a measurement such as SINR, SNR, or RSSI) is below a predefined/predetermined threshold for a predefined/predetermined period, it may consider it lost the connection with the associated mmW AP or the beam used is not good anymore. It may rely on one or more sub-7 GHz links to perform mmW link recovery or roaming.

The Short Beacon frame may comprise timestamp information for STAs in the mmW link for synchronization. The Short Beacon frame may comprise a BSSID of the mmW AP (i.e. the AP operating in the mmW link) for the non-AP STA to identify the BSS. The Short Beacon frame may comprise a MAC address of the mmW AP for the non-AP STA to identify the AP. The Short Beacon frame may comprise the MAC address of the AP MLD and the affiliated AP operating in the mmW link. The Short Beacon frame may comprise the MAC address of the Anchor AP affiliated with the same AP MLD as the mmW AP. The Short Beacon frame may comprise the TBTT of the Anchor link. The Short Beacon frame may comprise the TBTT of the mmW link which indicates the transmission time of a next set of Short Beacon frames.

A STA may maintain a TSF timer with modulus 264 counting in increments of 1 microsecond.

In an embodiment, a mmWSTA may maintain a TSF timer with modulus 2⁶⁴K counting in increments of 1/K microseconds, where K=4, 8, 16, etc. In this case, a (64+ceil(log₂(K))-bit Timestamp may not be sufficient. For example, if K=4, then a mmW STA may maintain a TSF timer with modulus 2⁽⁶⁴⁺²⁾ counting in increments of 0.25 microseconds. In aa first embodiment, a Timestamp field in a mmW link may be 66-bits long. In a second embodiment, the Timestamp field in a mmW link may be the same size as that in sub-7 GHz links (i.e. 64-bit long), which may be used to indicate the 64 most significant bits, or least significant bits, for the TSF timer, and a Timestamp mmW Extension field (e.g. 2-bit field) may be carried to indicate the two least significant bits (or most significant bits).

A next TBTT field in a Beacon frame or mmW Beacon Assistant frame or other type of frames to indicate the target mmW Beacon/short Beacon/mmW Beacon Assistant frame transmission time may be defined.

The next TBTT field may be with the same size that was used for sub-7 GHz TBTT but with a higher resolution. In the first embodiment, the next TBTT field may be the most significant 3 octets of the 4 least significant octets of the next TBTT. The next TBTT may be calculated based on the (64+ceil(log₂(K))-bit Timestamp. In the second embodiment, the next TBTT field may be the most significant 3 octets of the 4 least significant octets of the next TBTT. The next TBTT may be calculated based on the combination of the 64-bit Timestamp and ceil(log₂(K)-bit Timestamp mmW Extension.

The next TBTT field may be with the same size and same resolution as that that used for sub-7 GHz. A next TBTT mmW Extension field may be defined to comprise additional bits. With this method, the start time indication used in any scheduling signaling (e.g. TWT, Quiet element, TIM, etc.) used for mmW link may be the offset from the combination of the next TBTT and next mmW Extension to the start of the scheduled service period or time slot.

The TBTT Offset field/subfield may be carried in some element/field (e. g RNR element) to indicate the TBTT offset between two APs affiliated with the same AP MLD (e.g. the reported AP and a reporting AP). When the TBTT Offset field/subfield may be used to indicate the TBTT Offset between a sub-7 GHz AP and a mmW AP, the TBTT Offset field may be the offset in TUs, rounded down to the nearest TU or in a unit smaller than a TU and rounded down to the nearest unit. In order to obtain the correct TBTT Offset value, the timing on each link should be converted to the same unit and then the difference may be calculated.

An AP MLD which is capable of operating on a mmW link may indicate such capability in a capability element/field. A non-AP STA MLD which is capable of transmitting and receiving on a mmW link may indicate such capability in a capability element/field. The capability element/field may be carried in a management frame such as a Beacon frame, a Probe Request/Response frame, and a (Re)Association Request/Response frame There may be a very limited number of broadcast/multicast transmissions in a mmW link, and thus many broadcast/multicast information (e.g. used to be carried in a Beacon frame or a Probe Response frame) may need to be advertised in a sub-7 GHz band.

An AP, which may be referred to as a reporting AP, affiliated with an AP MLD may advertise an operation parameter of another AP, which may be referred to as a reported AP, affiliated with the same AP MLD. The reporting AP may operate on a sub-7 GHz link and the reported AP may operate on a mmW link. In an embodiment, a multi-link (ML) element, for example as introduced in 802.11be, may be modified to comprise information of mmW link(s) and may be referred to as an Enhanced ML element. An exemplary Enhanced ML element format is shown in FIG. 3.

In an embodiment, the format of a Basic ML element may be reused. The Type field in a Multi-Link Control field of a ML element may indicate a Basic variant of the ML element. In an embodiment, the format and the Element ID field, Length field, Element ID Extension field and Multi-Link Control field may be the same as the Basic ML element. The Common Info field and Link Info field may be modified.

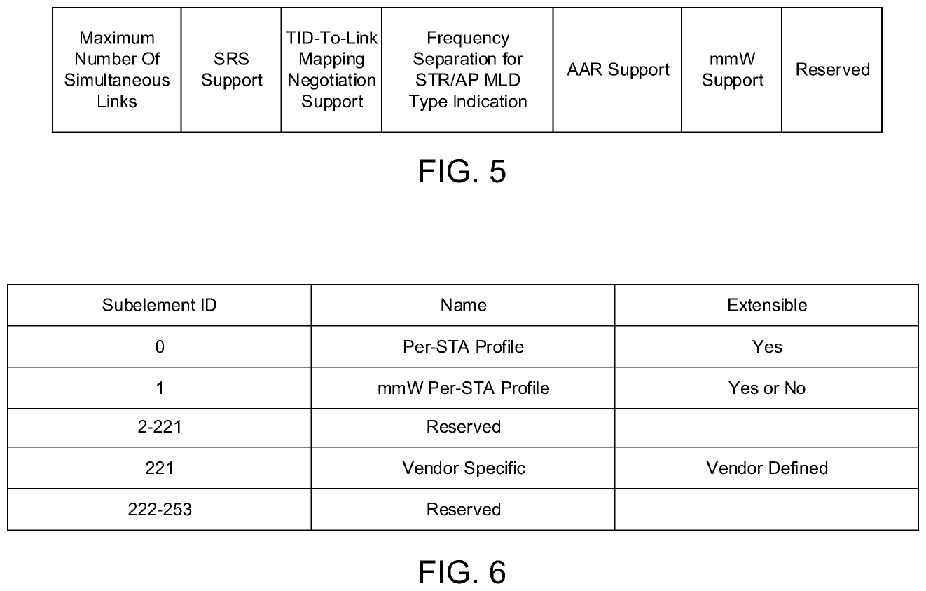

The format of the Common Info field may be the same as that in the Basic ML element, for example as shown in FIG. 4. However, the MLD Capabilities and Operations subfield in the Common Info field may be modified, for example as shown in FIG. 5.

In the MLD Capabilities and Operations subfield, a reserved bit may be used as a mmW Support subfield. The mmW Support subfield may indicate if mmW related signaling may be transmitted in the link where the reporting AP is operating. An AP affiliated with an AP MLD with mmW capability may set this bit, for example to true in one or more conditions such as: the AP MLD may be associated with at least one non-AP STA MLD which has an active mmW link; the AP MLD may have at least one active mmW link; and the AP MLD may intend to support non-AP MLDs with mmW link(s).

The Link Info field in the Basic ML element may be modified to support mmW operation. In a first embodiment, a mmW Per-STA subfield may be defined and optionally present in the Link Info field to support mmW operation. In a second embodiment, an existing Per-STA Profile subfield in the Link Info field may be updated to support mmW operation.

In an embodiment, a reserved subelement ID value, for the Link Info field of the ML element, may be used to indicate the mmW Per-STA subelement as shown in FIG. 6.

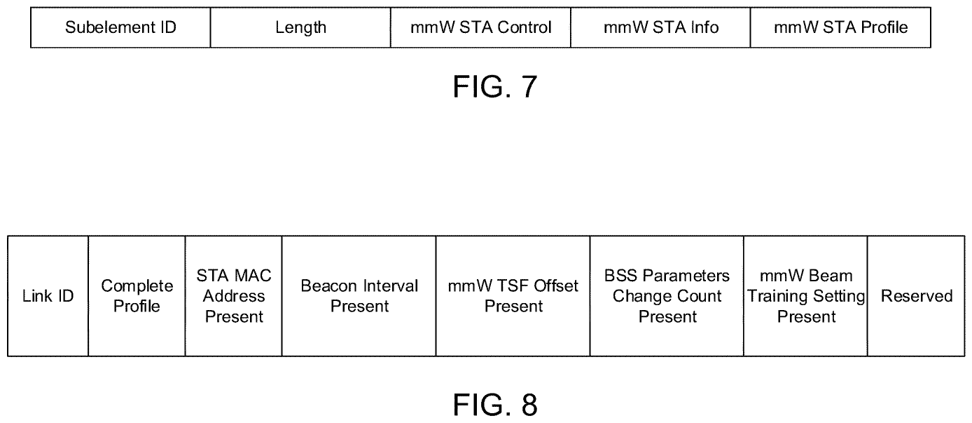

The mmW Per-STA Profile may be defined as shown in FIG. 7. The subelement ID subfield may be set to indicate that the subelement is a mmW Per-STA Profile subelement, as shown in FIG. 6.

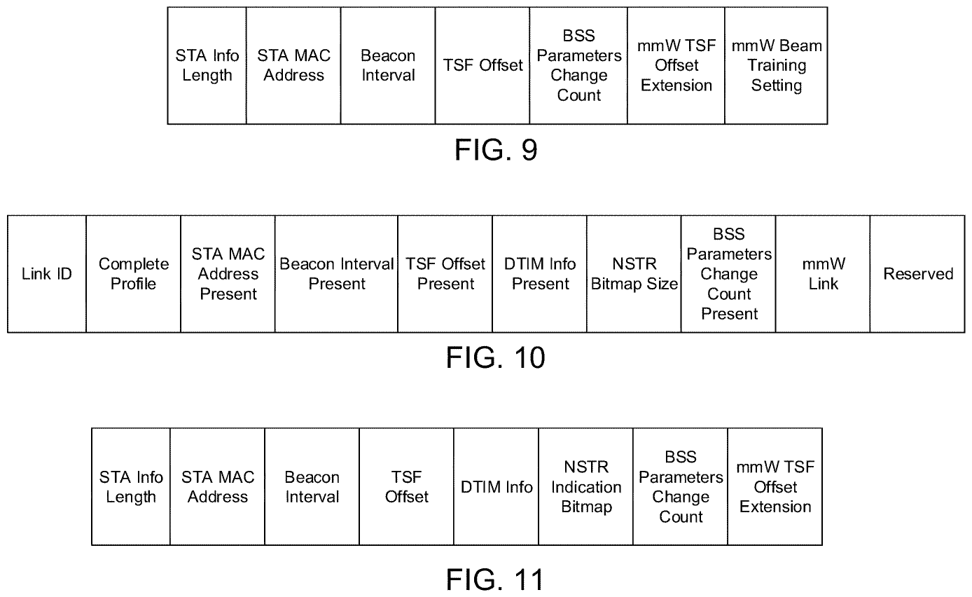

A mmW STA Control subfield of the mmW Per-STA Profile subelement format may be defined as shown in FIG. 8.

The following subfields may be defined in the STA Control subfield in the mmW Per-STA Profile subelement. In the mmW STA Control subfield in the mmW Per-STA Profile subelement, the subfields may be reused and modified to comprise mmW related information. The Link ID subfield may indicate a value that uniquely identifies the mmW link where the reported STA is operating on. The Complete Profile subfield may be set to a value, for example 1, to indicate that the mmW Per-STA Profile subelement of the Multi-Link element carries the complete profile of the reported STA. Otherwise, the Complete Profile subfield may set to a different value, for example 0. The STA MAC Address Present subfield may indicate the presence of the STA MAC Address subfield in the STA Info field. A STA operating on a mmW link may set the STA MAC Address Present subfield to a value, for example 1, when the element carries a complete profile. Otherwise, the STA may set the STA MAC Address Present subfield to a different value, for example 0. The Beacon Interval Present subfield may indicate the presence of the Beacon Interval subfield in the STA Info field. A non-AP STA may set the Beacon Interval Present subfield to a value, for example 0, in the transmitted Basic Multi-Link element. An AP affiliated with an AP MLD operating on a mmW link may set the Beacon Interval Present subfield to a value, for example 1, when the element carries a complete profile. The mmW TSF Offset Present subfield may indicate the presence of the TSF Offset subfield in the STA Info field. A non-AP STA affiliated with a non-AP MLD may set the TSF Offset Present subfield to a value, for example 0, in the transmitted Basic Multi-Link element. An AP affiliated with an AP MLD may set the TSF Offset Present subfield to a value, for example 1, when the element carries a complete profile. The BSS Parameters Change Count Present subfield may indicate the presence of the BSS Parameters Change Count subfield in the STA Info field. A non-AP STA affiliated with a non-AP MLD may set the BSS Parameters Change Count Present subfield to a value, for example 0, in the transmitted Basic Multi-Link element. If the Basic Multi-Link element carries a complete profile, an AP affiliated with an AP MLD may set this subfield to a value, for example 1.

The following subfields may be added in the mmWSTA Control subfield in the mmW Per-STA Profile subelement. A mmW Beam Training Setting Present subfield may indicate the presence of the mmW Beam Training Setting subfield in the STA Info field. A non-AP STA affiliated with a non-AP MLD may set the mmW Beam Training Setting Present subfield to a value, for example 1, in the transmitted Basic Multi-Link element if the Basic Multi-Link element carries a complete profile. Otherwise, the non-AP STA may set the mmW Beam Training Setting Present subfield to a different value, for example 0. An AP STA affiliated with an AP MLD may set the mmW Beam Training Setting Present subfield to a value, for example 1, in the transmitted Basic Multi-Link element if the Basic Multi-Link element carries a complete profile. Otherwise, the AP STA may set the mmW Beam Training Setting Present subfield to a different value, for example 0.

The mmW STA Info subfield may be defined as shown in FIG. 9. The STA Info Length, STA MAC Address, Beacon Interval, TSF Offset, and BSS Parameters Change Count subfields may be the same as that defined in a STA Info subfield of per-STA Profile subelement as in 802.11be.

A TSF timer or the Timestamp field in a sub-7 GHz link and a mmW link may have different resolution. In the below example, it may be assumed the TSF timer in mmW link(s) may be represented by more than 64 bits. The MSB of the timer may represent the same resolution as that of the sub-7 GHz link(s) and the rest of the bits may provide more accurate timing information. The TSF Offset subfield of the STA Info field may indicate the offset (T_{offset}) between the TSF timer of the reported AP (T_{A}) and the TSF timer of the reporting AP (T_{B}) and is encoded as a 2 s complement signed integer with units of 2 μs. If the reporting AP is operating on a mmW link, T_{offset} is calculated as Toffset=Floor((T_{A}-T_{B}([1:64])/2). Here T_{B}([1: 64]) indicates the 64 MSB of T_{B}.

The mmW TSF Offset Extension subfield may be present if the TSF Offset subfield is present and the Link ID or mmW Link subfield may indicate the Per-STA Profile is a profile for a mmW link. The TSF Offset Extension field may be used to comprise the information related to the bits in the mmW Timestamp which are not used in the TSF Offset calculation. For example, the mmW TSF Offset Extension subfield may comprise T_{B}([65: end]), if T_{B} has more than 64 bit.

The mmW Beam Training Setting subfield may be present if the mmW Beam Training Setting Present subfield in the mmW STA Control subfield is set to a value, for example 1. If the reporting STA is an AP, this field may indicate if the Short Beacon frames may be transmitted using sector sweep at the beginning of each Beacon Interval in the mmW link. If the reporting STA is a non-AP STA, this field set to a value, for example 1 or 0, that may indicate the reporting STA may have its mmW beam trained, and/or be satisfied with the trained beam. If the reporting STA is a non-AP STA, this field may be set to a value, for example 0 or 1, that may indicate the reporting STA may need to perform mmW beam training/tracking/retraining.

The mmW STA Profile field may comprise fields and elements based on one or more the following rules if the reporting STA is an AP. It may comprise the fields and elements in the same order and subject to the conditions as in a Beacon frame body where the format of each field and/or element may be the same as that transmitted by a DMG or EDMG STA. It may comprise the fields and elements in the same order and subject to the conditions as in a Probe Response frame body where the format of each field and/or element may be the same as that transmitted by a DMG or EDMG STA. It may comprise the fields and elements in the same order and subject to the conditions as in a (Re)Association Response frame body where the format of each field and/or element may be the same as that transmitted by a DMG or EDMG STA. It may comprise the fields and elements in the same order and subject to the conditions as in a combination of fields and elements necessary for mmW non-AP STAs affiliated with non-AP MLDs to obtain operational or BSS level information for mmW operation. It may comprise the fields and elements in the same order and subject to the conditions as in Short Beacon frame body.

The mmW STA Profile field may comprise fields and elements based on one or more the following rules if the reporting STA is a non-AP STA. It may comprise a Probe Request frame body where the format of each field and/or element may be the same as that transmitted by a DMG or EDMG STA. It may comprise a (Re) Association Request frame body where the format of each field and/or element may be the same as that transmitted by a DMG or EDMG STA. It may comprise a combination of fields and elements necessary for a mmW AP affiliated with an AP MLD to obtain operational or BSS level information for mmW operation.

In an embodiment (modified Per-STA subfield), an existing Per-STA Subfield as defined in 802.11be may be modified to include information necessary for mmW operation.

One bit or one field in the Per-STA Profile subelement may be used to indicate that the subelement comprises a profile for a mmW link. A range of Link IDs may be predetermined/predefined to indicate one or more mmW links. For example, a current Link ID subfield is a 4-bit field, which may comprise values from 0 to 15. A subset of values [a,b]⊆[0,15] may be used to indicate mmW links. A mmW Link subfield may be added to the STA Control field or other field in the Per-STA Profile to indicate the Per-STA Profile is a profile for a mmW link, as shown in FIG. 10.

In the STA Control field in the Per-STA Profile subfield, the Complete Profile subfield may be set to a value, for example 1, if the Link ID indicates a mmW link and/or the mmW Link subfield in the STA Control subfield is set to 1. In an embodiment, any management frame (e.g. Beacon frame, Probe Request/Response frame, (Re)Association Request/Response frame, etc.) may comprise a complete profile of a reported STA if the reported STA is a mmW STA and/or the Link ID indicates a mmW link and/or mmW Link subfield is set to 1.

Alternatively or additionally, when the Link ID subfield and/or mmW Link subfield in the STA Control subfield in the Per-STA Profile subfield may indicate a mmW link the following subfields in the STA Control subfield in Per-STA Profile subfield may be set to 1 (indicating that the corresponding subfields are carried in the Per-STA Profile subelement). A Complete Profile subfield may indicate that the Complete Profile subfield may be set to 1 for any management frame transmitted from the AP MLD. A STA MAC Address Present subfield may indicate that the STA MAC Address subfield may be set to 1 for any management frame transmitted from the AP MLD. A Beacon Interval Present subfield may indicate that the Beacon Interval subfield may be set to 1 for any management frame transmitted from the AP MLD. A TSF Offset Present subfield may indicate that the TSF Offset subfield may be set to 1 for any management frame transmitted from the AP MLD.

A new subfield, mmW TSF Offset Extension subfield, may be defined in the STA Info field as shown in FIG. 11. The TSF Offset and mmW TSF Offset Extension subfield are defined above.

In an embodiment, a mmW Beacon Assistant frame may be defined and transmitted in a sub-7 GHZ link to assist non-AP STA MLDs to acquire mmW link operation information. The mmW Beacon Assistant frame may comprise one or more elements/fields/subelements/subfields which may define mmW related BSS level capabilities, operation parameters, channels, functions and so on. The mmW related BSS level capabilities, operation parameters, channels, and functions may be defined in other subsections in the disclosure.

In an embodiment, the mmW Beacon Assistant frame may be transmitted once per beacon interval that is defined in the sub-7 GHz link.

In an embodiment, the mmW Beacon Assistant frame may be transmitted multiple times per beacon interval that is defined in the sub-7 GHz link. The mmW Beacon Assistant frame may be transmitted more frequent than the Beacon frame in the link.

In an embodiment, each mmW Beacon Assistant frame may comprise a Target mmW Beacon Assistant Transmission Time field which may indicate the transmission time of a next mmW Beacon Assistant frame. The target beacon transmission time (TBTT) field carried in the mmW Beacon Assistant frame may be used to identify the transmission time of next mmW Beacon Assistant frame. In an embodiment, the Beacon frame transmitted in the same link may indicate the target transmit time for the mmW Beacon Assistant frames.

A mmW Capabilities element may be defined and used by a STA, including an AP STA and a non-AP STA, to indicate the mmW capabilities. One or more information described below may be carried in the mmW Capabilities element.

A Hieratical beam training field may be carried in the mmW Capabilities element. This field may indicate if the STA supports hieratical beam training. With hieratical beam training, a STA may have layer beams. For example, Layer 1 beams may be coarse wide beams. Layer 2 beams may be finer narrow beams. There may be more than one Layer 2 beams within or corresponding to a Layer 1 beam. With Hieratical beam training, Layer 1 beam training may be performed first and a best Layer 1 beam may be selected. Then Layer 2 beam training may be performed based on the selected best Layer 1 beam. If Hieratical beam training is supported, the following information may be included: the number of Layer 1 beams/sectors or the number of coarse beams/sectors; the number of total Layer 2 beams/sectors or the number of fine beams/sectors; and the number of Layer 2 beams/sectors or the number of fine beams/sectors per Layer 1 beams/sector or coarse beam/sector.

A Receive Beam Training field may be carried in the mmW Capabilities element. This field may indicate if the STA supports receive beam training. If this field is set to a value that indicates that the STA does not support receive beam training (e.g. false), the STA may use an omni beam or a pseudo omni directional beam to receive and no receive beam training needed. Otherwise, the STA may be capable of using a directional beam to receive and receive beam training may be needed.

A mmW Beam/Antenna Reciprocity field may be carried in the mmW Capabilities element. This field may indicate if the transmit beams/antennas and receive beams/antennas of the STA are reciprocal. If they are reciprocal, then the transmit beam training may be used as receive beam selection for the same STA.

A number of receive mmW Antennas field may be carried in the mmW Capabilities element. This field may indicate the number of receive mmW Antennas supported by the STA/AP.

A number of sectors/beams field may be carried in the mmW Capabilities element. This field may indicate the total/maximum number of sectors/beams the STA/AP may use for sector sweep training or total/maximum number of Short Beacon frames in a Short Beacon frame set.

A supported mmW bandwidth field may be carried in the mmW Capabilities element. This field may indicate the supported number of data streams for each supported mmW bandwidth.

A supported mmW modulation and coding scheme (MCS) field may be carried in the mmW Capabilities element.

A supported number of data streams field may be carried in the mmW Capabilities element.

The mmW Capabilities element may be carried in a management frame such as a Beacon frame, a Probe Request/Response frame, a (Re)Association Request/Response frame, or a mmW Beacon Assistant frame, in a sub-7 GHz link. A Link ID or other type of link identity may be used together with this element to indicate the mmW link.

In an embodiment, a combined procedure of Short Beacon frame and mmW Beacon Assistant frame is disclosed.

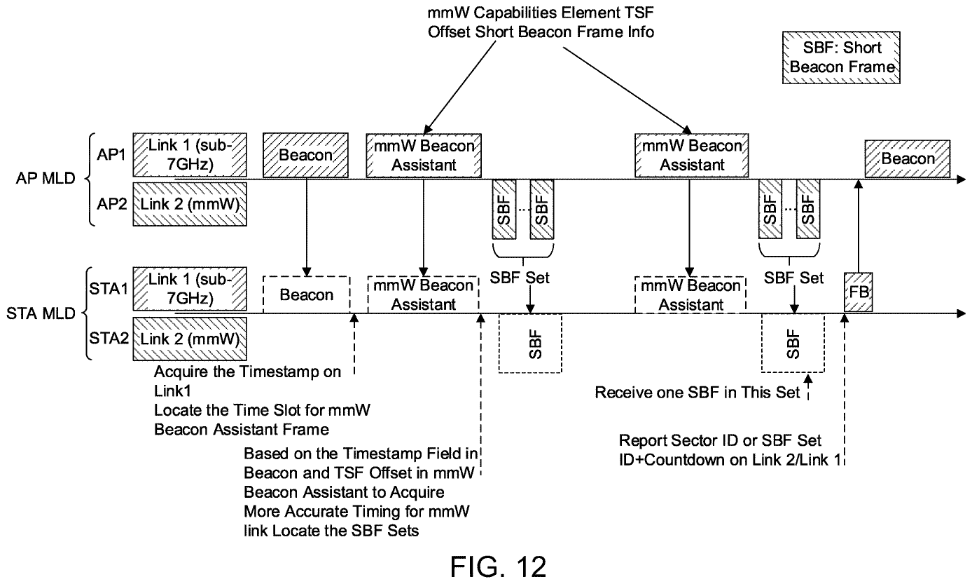

FIG. 12 shows an example procedure of a Short Beacon frame (SBF) and a multi-link Beacon Assistant frame (e.g. a mmW Beacon Assistant frame). In this example, an AP MLD has two affiliated APs (i.e. AP1 and AP2). AP1 affiliated with the AP MLD operates on link 1 which is, for example, a sub-7 GHz link and AP2 affiliated with the AP MLD operates on link 2 which is, for example, a mmW link. A non-AP STA MLD has two affiliated STAs (i.e. STA1 and STA2). STA1 affiliated with the STA MLD operates on link 1 and STA2 affiliated with the STA MLD operates on link 2.

AP2 may transmit Short Beacon frames on link 2 which may comprise limited BSS operation information about link 2. In an embodiment, the Short Beacon frames may be transmitted using sector sweep such that each Short Beacon frame may be transmitted using one antenna sector. A Short Beacon frame set may refer to a set of Short Beacon frames which may be transmitted sequentially and continuously in different sectors. We may use the term Short Beacon set to refer to the same concept of a Short Beacon frame set. The Short Beacon frames in a Short Beacon set may carry the same information except for one or more fields. For example, the Short Beacon frames in a Short Beacon set may be the same except for a Count Down ID field, a Sector ID field, etc. The Count Down ID field may comprise the number of the Short Beacon frames following the current one in the Short Beacon set. The Sector ID field may indicate the beam sector used to transmit the Short Beacon frame.

More detailed BSS operation information of link 2 may be carried in a frame transmitted on link 1. In this example, the mmW Beacon Assistant frame transmitted on link 1 may be used to comprise such information. In an embodiment, a set of Short Beacon frames transmitted on Link 2 may follow the mmW Beacon Assistant frame transmission on Link 1

Synchronization information may be carried in both the mmW Beacon Assistant frame and the Short Beacon frame. The Beacon interval of AP1 and AP2 may not be the same. The TSF timer of the links may not be the same.

A non-AP STA MLD may be associated with an AP MLD which operates on two active links (i.e. link 1 and link 2). STA1 affiliated with the STA MLD may monitor link 1.

STA1 may receive a Beacon frame. The beacon frame may be received over Link 1. The Beacon frame may be sent by AP1 affiliated with the AP MLD. Information carried in the Beacon frame may indicate link 2 is active. The information may be a Basic Multi-Link element. The Basic Multi-Link element may indicate a Target mmW Beacon Assistant Transmission Time field which may indicate the transmission time of a next mmW Beacon Assistant frame or a first mmW Beacon Assistant frame after the next Beacon frame transmitted on Link 1. STA1 may locate the starting time for the mmW Beacon Assistant frame transmission on Link 1 using the information from the Target mmW Beacon Assistant Transmission Time field. The Basic Multi-Link element may indicate a mmW Beacon Assistant Interval field that may indicate the number of time units (TU)s between mmW Beacon Assistant frames. The Basic Multi-Link element may indicate a Timestamp field which may be used for STA1 to set up its TSF timer. STA1 may update its TSF timer based on the Timestamp field in the Beacon frame. The STA MLD may save this TSF timer if the TSF timer on Link 2 may be determined by the TSF timer on Link 1 and other TSF related information.

STA1 may receive a mmW Beacon Assistant frame. The mmW Beacon Assistant frame may be sent over link 1. The mmW Beacon Assistant frame may be sent by AP1 affiliated with the AP MLD. STA1 may receive the mmW Beacon Assistant frame in a time slot that is based on the Target mmW Beacon Assistant Transmission Time field in the Beacon frame. The mmW Beacon Assistant frame may comprise a Target mmW Beacon Assistant Transmission Time field that may indicate the transmission time of a next mmW Beacon Assistant frame transmitted on Link 1. The mmW Beacon Assistant frame may comprise a mmW Beacon Assistant Interval field that may represent the number of time units (TU)s between mmW Beacon Assistant frames. The mmW Beacon Assistant frame may comprise a Target mmW Short Beacon Transmission Time field that may indicate the transmission time of a next set of Short Beacon frames transmitted on Link 2. The mmW Beacon Assistant frame may comprise a Short Beacon Set Size field that may indicate the number of Short Beacon frames in the Short Beacon Set. The mmW Beacon Assistant frame may comprise a Short Beacon Set ID field that may be used to identify the sector/beam group used to transmit the Short Beacon Set. The mmW Beacon Assistant frame may comprise a Short Beacon Interval field that may indicate the number of times between the end of the last Short Beacon frame in the current Short Beacon Set to the first Short Beacon frame in the next Short Beacon Set. The mmW Beacon Assistant frame may comprise a Timestamp field that may be used for STA2 to set up its TSF timer on Link 2 (e.g., the mmW link). STA2 may update its TSF timer based on the Timestamp field in the mmW Beacon Assistant frame. The mmW Beacon Assistant frame may comprise a TSF Offset subfield that may indicate the offset (T_{offset}) between the TSF timer of the reported AP (e.g., AP2) and the TSF timer of the reporting AP (e.g., AP1). STA2 may update its TSF timer on Link 2 based on the Timestamp field carried in the Beacon frame and TSF Offset field carried in the mmW Beacon Assistant frame. The mmW Beacon Assistant frame may comprise a mmW Operation element that may comprise information necessary for mmW operation (e.g. the mmW Operation Channel Width, Primary channel, Disabled Subchannel Bitmap etc.). The mmW Beacon Assistant frame may comprise a mmW Capabilities element. For example, the mmW Capabilities element may comprise information of one or more of: a hieratical beam training field, a receive beam training field, a mmW beam/antenna reciprocity field, a number of receive mmW antennas field, a number of sectors/beams field, a supported mmW bandwidth field, a supported mmW MCS, and a supported number of data streams field.

Based on the Timestamp field carried in the Beacon frame and the TSF Offset carried in the mmW Beacon Assistant frame in Link 1, STA2 may acquire or determine accurate timing for Link 2. Based on the Target mmW Short Beacon Transmission Time field carried in the mmW Beacon Assistant frame in Link 1, STA2 may determine the transmission time of the Short Beacon set and the Short Beacon frames.

STA2 may receive zero or one or more of the Short Beacon frames transmitted by AP2 affiliated with the AP MLD on Link 2. The Short Beacon frames may be transmitted using sector sweep (i.e., the same Short Beacon frames may be repeated and transmitted using different antenna sectors/beams). STA2 may be able to detect some of the transmitted Short Beacon frames but not necessarily all depending on whether the antenna sectors/beams are suitable for it. The Short Beacon frame may comprise a Sector Sweep field that may indicate a countdown or counting number which may indicate a position of a Short Beacon frame in the Short Beacon set. A Sector ID may indicate the antenna beam index or antenna sector index. The Short Beacon frame may comprise a Timestamp field. STA2 may set up its TSF timer on Link 2 based on the Timestamp filed in the Short Beacon frame. The Short Beacon frame may comprise a Short Beacon Interval field that may indicate the number of times between the end of the last Short Beacon frame in the current Short Beacon Set to the first Short Beacon frame in the next Short Beacon Set.

After reception of one or more Short Beacon frames by STA2 on Link 2, or after the completion of all Short Beacon sets on Link 2, STA1 may send feedback information. The feedback information may comprise information regarding the received Sector ID information. The feedback information may be sent to AP1 on Link 1. In an embodiment, STA1 may acquire the channel on Link 1 through CSMA/CA or trigger based channel access and transmit a Feedback frame (which may be referred to as a Multi-Link Feedback frame) which may comprise the best sector(s) on which STA2 may receive the Short Beacon frame(s). The Feedback frame may comprise a Link ID that may indicate the ID of Link 2 so that the AP MLD may know the Feedback frame comprises information regarding Link 2. The Feedback frame may comprise a Best Sector ID(s) information that may indicate the sector(s) with the best/highest received powers. The Best Sector ID(s) information may be used for beamforming. The Feedback frame may comprise a Worst Sector ID(s) information that may indicate the sector(s) with the worst/lowest received powers or sectors on which the received power is below a threshold. The Worst Sector ID(s) information may be used for interference avoidance. The Feedback frame may comprise a Short Beacon Set ID that may be used to identify the group of sectors/beams used to transmit the short beacon set. The Feedback frame may comprise a Countdown or Counting number carried in the Sector Sweep field of the received Short Beacon frame that may indicate a position of the Short Beacon frame in the Short Beacon set.

If the best Sector ID(s) information are explicitly sent in the Short Beacon frame, then it is enough to identify the best sector(s). Otherwise, the combination of Short Beacon Set IDs and Countdown/Counting numbers may be used to identify the best sector(s). The same or similar method may be used for the worst Sector IDs.

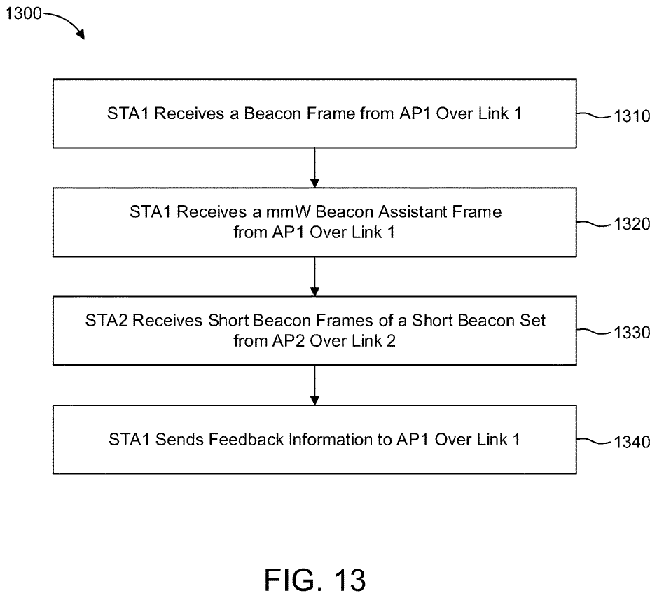

FIG. 13 shows an example method of using a Short Beacon frame and a mmW Beacon Assistant frame.

A first STA (STA1) may receive a first management frame/first type of management frame (e.g. Beacon frame) 1310. STA1 may be affiliated with a STA MLD. STA1 may be a non-AP STA. A second STA (STA2) may be affiliated with the STA MLD. STA2 may be a non-AP STA. The Beacon frame may be received over a first link (Link 1). Link 1 may be a sub-7 GHz link. STA1 may receive the Beacon frame from a first AP (AP1). AP1 may be affiliated with an AP MLD. A second AP (AP2) may be affiliated with the AP MLD. Information carried in the Beacon frame may indicate that a second link (Link 2) is active. Link 2 may be a mmW link. The information in the Beacon frame may be a Basic Multi-Link element. The Basic Multi-Link element may indicate a Target multi-link (e.g. mmW) Beacon Assistant Transmission Time field which may indicate the transmission time of a next multi-link (e.g. mmW) Beacon Assistant frame or a first mmW Beacon Assistant frame after the next Beacon frame transmitted on Link 1. STA1 may locate the starting time for the mmW Beacon Assistant frame transmission on Link 1 using the information from the Target mmW Beacon Assistant Transmission Time field. The Basic Multi-Link element may indicate a multi-link (e.g. mmW) Beacon Assistant Interval field that may indicate the number of time units (TU)s between mmW Beacon Assistant frames. The Basic Multi-Link element may indicate a Timestamp field which may be used for STA1 to set up its TSF timer. STA1 may update its TSF timer based on the Timestamp field in the Beacon frame. The STA MLD may save this TSF timer if the TSF timer on Link 2 may be determined by the TSF timer on Link 1 and other TSF related information.

STA1 may receive a second management frame/second type of management frame (e.g. multi-link (e.g. mmW) Beacon Assistant frame) 1320. STA1 may receive the mmW Beacon Assistant frame over Link 1. STA1 may receive the mmW Beacon Assistant frame from AP1.

STA1 may receive the mmW Beacon Assistant frame in a time slot that is based on the Target mmW Beacon Assistant Transmission Time field in the Beacon frame. The mmW Beacon Assistant frame may comprise a Target mmW Beacon Assistant Transmission Time field that may indicate the transmission time of a next mmW Beacon Assistant frame transmitted on Link 1. The mmW Beacon Assistant frame may comprise a mmW Beacon Assistant Interval field that may represent the number of time units (TU)s between mmW Beacon Assistant frames. The mmW Beacon Assistant frame may comprise a Target mmW Short Beacon Transmission Time field that may indicate the transmission time of a next set of Short Beacon frames transmitted on Link 2. The mmW Beacon Assistant frame may comprise a Short Beacon Set Size field that may indicate the number of Short Beacon frames in the Short Beacon Set. The mmW Beacon Assistant frame may comprise a Short Beacon Set ID field that may be used to identify the sector/beam group used to transmit the Short Beacon Set. The mmW Beacon Assistant frame may comprise a Short Beacon Interval field that may indicate the number of times between the end of the last Short Beacon frame in the current Short Beacon Set to the first Short Beacon frame in the next Short Beacon Set. The mmW Beacon Assistant frame may comprise a Timestamp field that may be used for STA2 to set up its TSF timer on Link 2 (e.g., the mmW link). STA2 may update its TSF timer based on the Timestamp field in the mmW Beacon Assistant frame. The mmW Beacon Assistant frame may comprise a TSF Offset subfield that may indicate the offset (T_{offset}) between the TSF timer of the reported AP (e.g., AP2) and the TSF timer of the reporting AP (e.g., AP1). STA2 may update its TSF timer on Link 2 based on the Timestamp field carried in the Beacon frame and TSF Offset field carried in the mmW Beacon Assistant frame. The mmW Beacon Assistant frame may comprise a mmW Operation element that may comprise information necessary for mmW operation (e.g. the mmW Operation Channel Width, Primary channel, Disabled Subchannel Bitmap etc.). The mmW Beacon Assistant frame may comprise a mmW Capabilities element. For example, the mmW Capabilities element may comprise information of one or more of: a hieratical beam training field, a receive beam training field, a mmW beam/antenna reciprocity field, a number of receive mmW antennas field, a number of sectors/beams field, a supported mmW bandwidth field, a supported mmW MCS, and a supported number of data streams field.

STA2 may receive one of more third management frames/third type of management frames (e.g. Short Beacon frames (SBFs)) of a set of SBFs (Short Beacon set) 1330. STA2 may receive one or more Short Beacon frames in the Short Beacon set over Link 2. The Short Beacon set may be transmitted by AP2 over link 2.

Based on the Timestamp field carried in the Beacon frame and the TSF Offset carried in the mmW Beacon Assistant frame in Link 1, STA2 may acquire or determine accurate timing for Link 2. Based on the Target mmW Short Beacon Transmission Time field carried in the mmW Beacon Assistant frame in Link 1, STA2 may determine the transmission time of the Short Beacon set and the Short Beacon frames.

The Short Beacon frames may be transmitted or received using sector sweep (i.e., the same Short Beacon frames may be repeated and transmitted using different antenna sectors/beams). STA2 may be able to detect some of the transmitted Short Beacon frames but not necessarily all depending on whether the antenna sectors/beams are suitable for it. The Short Beacon frame may comprise a Sector Sweep field that may indicate a countdown or counting number which may indicate a position of a Short Beacon frame in the Short Beacon set. A Sector ID may indicate the antenna beam index or antenna sector index. The Short Beacon frame may comprise a Timestamp field. STA2 may set up its TSF timer on Link 2 based on the Timestamp filed in the Short Beacon frame. The Short Beacon frame may comprise a Short Beacon Interval field that may indicate the number of times between the end of the last Short Beacon frame in the current Short Beacon Set to the first Short Beacon frame in the next Short Beacon Set.

STA1 may send feedback information (e.g. feedback frame) 1340. STA1 may send the feedback information to AP1. STA1 may send the feedback information over Link 1. The feedback information may be sent after reception of one or more Short Beacon frames by STA2 on Link 2, or after the completion of all Short Beacon sets on Link 2.

The feedback information may comprise information regarding the received Sector ID information. In an embodiment, STA1 may acquire the channel on Link 1 through CSMA/CA or trigger based channel access and transmit a Feedback frame (which may be referred to as a Multi-Link Feedback frame) which may comprise the best sector(s) on which STA2 may receive the Short Beacon frame(s). The Feedback frame may comprise a Link ID that may indicate the ID of Link 2 so that the AP MLD may know the Feedback frame comprises information regarding Link 2. The Feedback frame may comprise a Best Sector ID(s) information that may indicate the sector(s) with the best/highest received powers. The Best Sector ID(s) information may be used for beamforming. The Feedback frame may comprise a Worst Sector ID(s) information that may indicate the sector(s) with the worst/lowest received powers or sectors on which the received power is below a threshold. The Worst Sector ID(s) information may be used for interference avoidance. The Feedback frame may comprise a Short Beacon Set ID that may be used to identify the group of sectors/beams used to transmit the short beacon set. The Feedback frame may comprise a Countdown or Counting number carried in the Sector Sweep field of the received Short Beacon frame that may indicate a position of the Short Beacon frame in the Short Beacon set.

If the best Sector ID(s) information are explicitly sent in the Short Beacon frame, then it is enough to identify the best sector(s). Otherwise, the combination of Short Beacon Set IDs and Countdown/Counting numbers may be used to identify the best sector(s). The same or similar method may be used for the worst Sector IDs. For example, if the worst Sector ID(s) information are explicitly sent in the Short Beacon frame, then it is enough to identify the worst sector(s). Otherwise, the combination of Short Beacon Set IDs and Countdown/Counting numbers may be used to identify the worst sector(s).

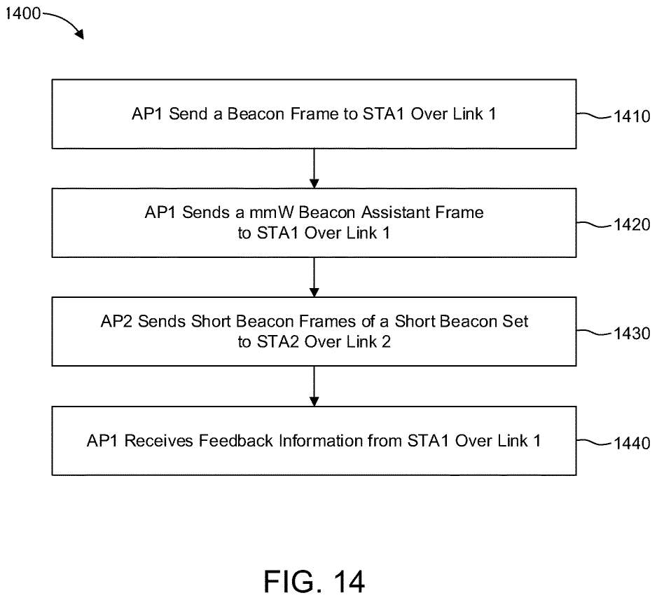

FIG. 14 shows an example method of using a Short Beacon frame and a mmW Beacon Assistant frame.

A first AP (AP1) may send a first management frame/first type of management frame (e.g. Beacon frame) 1410. AP1 may be affiliated with an AP MLD. A second AP (AP2) may be affiliated with the AP MLD. The Beacon frame may be sent over a first link (Link 1). Link 1 may be a sub-7 GHz link. AP1 may send the Beacon frame to a first STA (STA1). STA1 may be affiliated with a STA MLD. STA1 may be a non-AP STA. A second STA (STA2) may be affiliated with the STA MLD. STA2 may be a non-AP STA.

Information carried in the Beacon frame may indicate that a second link (Link 2) is active. Link 2 may be a mmW link. The information in the Beacon frame may be a Basic Multi-Link element. The Basic Multi-Link element may indicate a Target multi-link (e.g. mmW) Beacon Assistant Transmission Time field which may indicate the transmission time of a next multi-link (e.g. mmW) Beacon Assistant frame or a first mmW Beacon Assistant frame after the next Beacon frame transmitted on Link 1. STA1 may locate the starting time for the mmW Beacon Assistant frame transmission on Link 1 using the information from the Target mmW Beacon Assistant Transmission Time field. The Basic Multi-Link element may indicate a multi-link (e.g. mmW) Beacon Assistant Interval field that may indicate the number of time units (TU)s between mmW Beacon Assistant frames. The Basic Multi-Link element may indicate a Timestamp field which may be used for STA1 to set up its TSF timer. STA1 may update its TSF timer based on the Timestamp field in the Beacon frame. The STA MLD may save this TSF timer if the TSF timer on Link 2 may be determined by the TSF timer on Link 1 and other TSF related information.

AP1 may send a second management frame/second type of management frame (e.g. multi-link (e.g. mmW) Beacon Assistant frame) 1420. AP1 may send the mmW Beacon Assistant frame over Link 1. AP1 may send the mmW Beacon Assistant frame to STA1.

AP1 may send the mmW Beacon Assistant frame in a time slot that is based on the Target mmW Beacon Assistant Transmission Time field in the Beacon frame. The mmW Beacon Assistant frame may comprise a Target mmW Beacon Assistant Transmission Time field that may indicate the transmission time of a next mmW Beacon Assistant frame transmitted on Link 1. The mmW Beacon Assistant frame may comprise a mmW Beacon Assistant Interval field that may represent the number of time units (TU)s between mmW Beacon Assistant frames. The mmW Beacon Assistant frame may comprise a Target mmW Short Beacon Transmission Time field that may indicate the transmission time of a next set of Short Beacon frames transmitted on Link 2. The mmW Beacon Assistant frame may comprise a Short Beacon Set Size field that may indicate the number of Short Beacon frames in the Short Beacon Set. The mmW Beacon Assistant frame may comprise a Short Beacon Set ID field that may be used to identify the sector/beam group used to transmit the Short Beacon Set. The mmW Beacon Assistant frame may comprise a Short Beacon Interval field that may indicate the number of times between the end of the last Short Beacon frame in the current Short Beacon Set to the first Short Beacon frame in the next Short Beacon Set. The mmW Beacon Assistant frame may comprise a Timestamp field that may be used for STA2 to set up its TSF timer on Link 2 (e.g., the mmW link). STA2 may update its TSF timer based on the Timestamp field in the mmW Beacon Assistant frame. The mmW Beacon Assistant frame may comprise a TSF Offset subfield that may indicate the offset (T_{offset}) between the TSF timer of the reported AP (e.g., AP2) and the TSF timer of the reporting AP (e.g., AP1). STA2 may update its TSF timer on Link 2 based on the Timestamp field carried in the Beacon frame and TSF Offset field carried in the mmW Beacon Assistant frame. The mmW Beacon Assistant frame may comprise a mmW Operation element that may comprise information necessary for mmW operation (e.g. the mmW Operation Channel Width, Primary channel, Disabled Subchannel Bitmap etc.). The mmW Beacon Assistant frame may comprise a mmW Capabilities element. For example, the mmW Capabilities element may comprise information of one or more of: a hieratical beam training field, a receive beam training field, a mmW beam/antenna reciprocity field, a number of receive mmW antennas field, a number of sectors/beams field, a supported mmW bandwidth field, a supported mmW MCS, and a supported number of data streams field.

AP2 may send one or more third management frames/third type of management frames (e.g. Short Beacon frames (SBFs)) of a set of SBFs (Short Beacon set) 1430. AP2 may send one or more Short Beacon frames in the Short Beacon set over Link 2. The Short Beacon set may be sent to STA2 over link 2.

Based on the Timestamp field carried in the Beacon frame and the TSF Offset carried in the mmW Beacon Assistant frame in Link 1, STA2 may acquire or determine accurate timing for Link 2. Based on the Target mmW Short Beacon Transmission Time field carried in the mmW Beacon Assistant frame in Link 1, STA2 may determine the transmission time of the Short Beacon set and the Short Beacon frames.

The Short Beacon frames may be transmitted or received using sector sweep (i.e., the same Short Beacon frames may be repeated and transmitted using different antenna sectors/beams). STA2 may be able to detect some of the transmitted Short Beacon frames but not necessarily all depending on whether the antenna sectors/beams are suitable for it. The Short Beacon frame may comprise a Sector Sweep field that may indicate a countdown or counting number which may indicate a position of a Short Beacon frame in the Short Beacon set. A Sector ID may indicate the antenna beam index or antenna sector index. The Short Beacon frame may comprise a Timestamp field. STA2 may set up its TSF timer on Link 2 based on the Timestamp filed in the Short Beacon frame. The Short Beacon frame may comprise a Short Beacon Interval field that may indicate the number of times between the end of the last Short Beacon frame in the current Short Beacon Set to the first Short Beacon frame in the next Short Beacon Set.

AP1 may receive feedback information (e.g. feedback frame) 1440. AP1 may receive the feedback information from STA1. AP1 may receive the feedback information over Link 1. The feedback information may be received after reception of one or more Short Beacon frames by STA2 on Link 2, or after the completion of all Short Beacon sets on Link 2.

The feedback information may comprise information regarding the received Sector ID information. In an embodiment, STA1 may acquire the channel on Link 1 through CSMA/CA or trigger based channel access and transmit a Feedback frame (which may be referred to as a Multi-Link Feedback frame) which may comprise the best sector(s) on which STA2 may receive the Short Beacon frame(s). The Feedback frame may comprise a Link ID that may indicate the ID of Link 2 so that the AP MLD may know the Feedback frame comprises information regarding Link 2. The Feedback frame may comprise a Best Sector ID(s) information that may indicate the sector(s) with the best/highest received powers. The Best Sector ID(s) information may be used for beamforming. The Feedback frame may comprise a Worst Sector ID(s) information that may indicate the sector(s) with the worst/lowest received powers or sectors on which the received power is below a threshold. The Worst Sector ID(s) information may be used for interference avoidance. The Feedback frame may comprise a Short Beacon Set ID that may be used to identify the group of sectors/beams used to transmit the short beacon set. The Feedback frame may comprise a Countdown or Counting number carried in the Sector Sweep field of the received Short Beacon frame that may indicate a position of the Short Beacon frame in the Short Beacon set.

If the best Sector ID(s) information are explicitly sent in the Short Beacon frame, then it is enough to identify the best sector(s). Otherwise, the combination of Short Beacon Set IDs and Countdown/Counting numbers may be used to identify the best sector(s). The same or similar method may be used for the worst Sector IDs. For example, if the worst Sector ID(s) information are explicitly sent in the Short Beacon frame, then it is enough to identify the worst sector(s). Otherwise, the combination of Short Beacon Set IDs and Countdown/Counting numbers may be used to identify the worst sector(s).

The methods, procedures and signaling disclosed herein be combined.

Although the features and elements of the present disclosure are described in the preferred embodiments in particular combinations, each feature or element may be used alone without the other features and elements of the preferred embodiments or in various combinations with or without other features and elements of the present disclosure.

Although the solutions described herein consider 802.11 specific protocols, it is understood that the solutions described herein are not restricted to this scenario and are applicable to other wireless systems as well.

Although SIFS is used to indicate various inter frame spacing in the examples of the designs and procedures, all other inter frame spacing such as RIFS, AIFS, DIFS or other agreed time interval could be applied in the same solutions.

Although a sub-7 GHz link/band is used to refer to a link in MLO system where the control/management frames may be transmitted for a mmW link/band, it may be replaced by a more general term such as lower frequency link/band.

Although we define a first field/subfield/element/subelement in a second field/subfield/element/subelement/frame, the first field/subfield/element/subelement may be carried in other fields/subfields/elements/subelements/frames to indicate the same information.

Although the methods, signaling, and procedures described are based on sub-7 GHz link/band and mmW link/band, they may be generated to cases where two or more links/bands exist. For example, a mmW link may be replaced by link 1, and a sub-7 GHz link may be replaced by link 2. For example, the mmW Beacon Assistant frame may be replaced by Beacon Assistant frame or Multi-Link Beacon Assistant frame.

Long Training Field (LTF) may be any type of predefined sequences that are known at both transmitter and receiver sides.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1. A method for use in a station (STA) multilink device (MLD) that comprises a first STA affiliated with the STA MLD and a second STA affiliated with the STA MLD, the method comprising:
receiving, by the first STA from a first access point (AP) affiliated with an AP MLD, a first management frame over a first link, wherein the first management frame comprises timestamp information;
receiving, by the first STA from the first AP, a second management frame over the first link, wherein the second management frame comprises a time synchronization function (TSF) offset; and
receiving, by the second STA from a second AP affiliated with the AP MLD, based on the timestamp information and the TSF offset, at least one third management frame, from a set of third management frames, over a second link.

2. The method of claim 1, wherein the at least one third management frame from the set of third management frames are transmitted using a sector sweep, wherein each third management frame is transmitted using one antenna sector.

3. The method of claim 1, wherein the first link is a sub-7 GHz link and the second link is a millimeter wave (mmW) link.

4. The method of claim 1, further comprising:
sending, by the first STA to the first AP over the first link, feedback information regarding the second link and the received at least one third management frame, wherein the feedback information regarding the received at least one third management frame comprises a sector identification, a third management frameset identification, or countdown information.

5. The method of claim 1, further comprising:
determining, by the second STA, a transmission time of the at least one third management frame based on a target third management frame transmission time field in the second management frame.

6. The method of claim 1, wherein the first management frame comprises a basic multi-link element, wherein the basic multi-link indicates that the second link is active.

7. The method of claim 1, wherein the first management frame is a beacon frame, and wherein the second management frame is a multi-link beacon assistant frame, and wherein the third management frame is a short beacon frame (SBF).

8. The method of claim 1, wherein the second management frame comprises:
a target multi-link beacon assistant transmission time field that indicates a transmission time of a next second management frame transmitted over the first link;
a multi-link beacon assistant interval field that indicates a number of time units (TU)s between second management frames;
a target short beacon transmission time field that indicates a transmission time of a next set of third management frames transmitted over the second link;
a short beacon set size field that indicates a number of third management frames in the set of third management frames;
a short beacon interval field that indicates a number of times between an end of a last third management frame in a current set of third management frames to a first third management frame in a next set of third management frames;
a timestamp field;
a TSF offset subfield that indicates an offset between a TSF timer of the first AP and a TSF timer of the second AP;
a multi-link operation element that comprises information for multi-link operation; and
a multi-link capabilities element.

9. The method of claim 8, wherein the multi-link capabilities element comprises:
a hieratical beam training field; a receive beam training field; a mmW beam or antenna reciprocity field; a number of receive mmW antennas field; a number of sectors or beams field; a supported mmW bandwidth field; a supported mmW modulation and coding scheme (MCS) field; and a supported number of data streams field.

10. The method of claim 1, wherein the at least one third management frame comprises:
a sector sweep field that indicates a position of the third management frame in the set of third management frames;
a timestamp field; and
a short beacon interval field that indicates a number of times between an end of a last third management frame in a current set of third management frames to a first third management frame in a next set of third management frames.

11. A station (STA) multilink device (MLD) comprising:
a first STA affiliated with the STA MLD; and
a second STA affiliated with the STA MLD, wherein:
a receiver of the first STA affiliated with the STA MLD is configured to receive, from a first access point (AP) affiliated with an AP MLD, a first management frame over a first link, wherein the first management frame comprises timestamp information;
the receiver of the first STA affiliated with the STA MLD is further configured to receive, from the first AP, a second management frame over the first link, wherein the second management frame comprises a time synchronization function (TSF) offset; and
a receiver of the second STA affiliated with the STA MLD is configured to receive, from a second AP affiliated with the AP MLD, based on the timestamp information and the TSF offset, at least one third management frame, from a set of third management frames, over a second link.

12. The STA MLD of claim 11, wherein the at least one third management frame from the set of third management frames are transmitted using a sector sweep, wherein each third management frame is transmitted using one antenna sector.

13. The STA MLD of claim 11, wherein the first link is a sub-7 GHz link and the second link is a millimeter wave (mmW) link.

14. The STA MLD of claim 11, wherein:
a transmitter of the first STA affiliated with the STA MLD is configured to send, to the first AP over the first link, feedback information regarding the second link and the received at least one third management frame, wherein the feedback information regarding the received at least one third management frame comprises a sector identification, a third management frameset identification, or countdown information.

15. The STA MLD of claim 11, wherein:
a processor of the second STA affiliated with the STA MLD is configured to determine a transmission time of the at least one third management frame based on a target third management frame transmission time field in the second management frame.

16. The STA MLD of claim 11, wherein the first management frame comprises a basic multi-link element, wherein the basic multi-link indicates that the second link is active.

17. The STA MLD of claim 11, wherein the first management frame is a beacon frame, and wherein the second management frame is a multi-link beacon assistant frame, and wherein the third management frame is a short beacon frame (SBF).

18. The STA MLD of claim 11, wherein the second management frame comprises:
a target multi-link beacon assistant transmission time field that indicates a transmission time of a next second management frame transmitted over the first link;
a multi-link beacon assistant interval field that indicates a number of time units (TU)s between second management frames;
a target short beacon transmission time field that indicates a transmission time of a next set of third management frames transmitted over the second link;
a short beacon set size field that indicates a number of third management frames in the set of third management frames;
a short beacon interval field that indicates a number of times between an end of a last third management frame in a current set of third management frames to a first third management frame in a next set of third management frames;
a timestamp field;
a TSF offset subfield that indicates an offset between a TSF timer of the first AP and a TSF timer of the second AP;
a multi-link operation element that comprises information for multi-link operation; and
a multi-link capabilities element.

19. The STA MLD of claim 18, wherein the multi-link capabilities element comprises:
a hieratical beam training field; a receive beam training field; a mmW beam or antenna reciprocity field; a number of receive mmW antennas field; a number of sectors or beams field; a supported mmW bandwidth field; a supported mmW modulation and coding scheme (MCS) field; and a supported number of data streams field.

20. The STA MLD of claim 11, wherein the at least one third management frame comprises:
a sector sweep field that indicates a position of the third management frame in the set of third management frames;
a timestamp field; and
a short beacon interval field that indicates a number of times between an end of a last third management frame in a current set of third management frames to a first third management frame in a next set of third management frames.
